(19) United States
(12) Patent Application Publication
(10) Pub. No.: US 2013/0075960 A1
(43) Pub. Date: Mar. 28, 2013

(54) Manufacturing Method and Apparatus for a Hollow Molded Part

(71) Applicant: Harumasa Hatakeyama, Saku-shi (JP)

(72) Inventor: Harumasa Hatakeyama, Saku-shi (JP)

(73) Assignee: HEIWA KAGAKU INDUSTRY CO., LTD., Ichikawa-shi, Chiba (JP)

(21) Appl. No.: 13/702,554

(22) PCT Filed: Jul. 19, 2011
(86) PCT No.: PCT/JP2011/066316

§ 371 Date: Dec. 6, 2012

(30) Foreign Application Priority Data
Jul. 16, 2010 (JP) 2010-161672

(51) Int. Cl. B29C 41/00

(52) U.S. Cl. CPC B29C 41/006
USPC 264/484; 425/174.8 E

(57) ABSTRACT

Manufacturing method and apparatus for a hollow molded part manufactured by spraying a molding material into a mold utilizing the principle of electrostatic coating. The method comprises a spraying step for forming a resin layer by spraying liquid resin with a differential electrical potential relative to the mold into a mold capable of separation into two or more parts from a spray fixture inserted from an opening portion in said mold; a solidifying step for solidifying the resin layer; a mold parting step for opening the mold relative to the spray fixture and parting the solidified resin layer from the mold while it is held in the spray fixture; and a removal step for removing from the spray fixture the resin layer held in the spray fixture.

### TECHNICAL FIELD

The present invention pertains to a manufacturing method and apparatus for a hollow molded part manufactured by spraying a molding material into a mold utilizing the principle of electrostatic coating.

### BACKGROUND ART

The manufacture of hollow molded parts was conventionally accomplished by extruding thermoplastic viscous resin into a pipe shape and expanding it by air blowing in the direct-blow forming method, or by fabricating a preform body in the shape of a test tube by injection molding, then injection blow-molding to expand the part by air blowing or the like.

Direct blow molding can be carried out with only a female mold, and laminated resin hollow molded parts can be inexpensively manufactured by simultaneous extrusion of multiple resins. Since injection blow molding fabricates preforms, the final product weight, wall thickness, and the like of the final molded product are stable, so that mass produced parts can be efficiently manufactured.

However, because these blow moldings stretch the resin, the problem arises that thick and thin places are created in the resin depending on the amount of stretching (the blow ratio).

In addition, because these molding methods homogenize resin viscosity, it is necessary to knead the resin in the stage prior to blow molding in order to release air bubbles in the molten resin, leading to the problem that large amounts of thermal energy are required.

As a technology with an extremely low equipment cost relative to the above-described blow molding machines or injection molding machines, with which the thickness of the molded parts can easily be made uniform, a plastic part molding apparatus has been proposed (e.g., see Patent Citation 1) in which material powder is sprayed into the concave surface of a mold with an opening using an electrostatic spraying apparatus, said mold and sprayed-on molding material are cyclically heated, then said mold and sprayed-on molded material are cooled and parted.

### PRIOR ART REFERENCES

### Patent Reference

Patent Citation 1: JP-B-S44-32673

### SUMMARY OF THE INVENTION

### Problems the Invention Seeks to Resolve

In the above-described plastic product molding apparatus, disclosed in Patent Citation 1, a spray head 46 for spraying electrostatically charged plastic polyethylene particles into the mold 28 is disposed on the outside of a drum 12 attached to multiple molds 28 with holes; open form containers such as trays can be formed, but hollow molded parts such as bottles cannot be formed.

The plastic product molding apparatus disclosed in Patent Citation 1 also requires an ejector 72 or the like for ejecting the resin layer, i.e., the target molded part, from the mold after solidifying. The ejector 72 must have a strength capable of withstanding the dynamic load placed on the target molded part when the target molded part is ejected from the mold, and does not permit thin-walled molded parts such as thin films to be obtained.

In the plastic product molding apparatus disclosed in Patent Citation 1, a step is furthermore necessary to utilize the differential in thermal shrinkage between the mold and the plastic and cool the mold to facilitate separation of the product; in addition pre-processing such as coating the mold with a liquid parting agent is also required.

### Object of the Invention

The present invention was undertaken in light of the above-described problems pertaining to conventional hollow molded part manufacturing methods, and has the object of providing a hollow molded part manufacturing method and apparatus capable of easily and efficiently manufacturing extremely thin hollow molded parts of uniform thickness in a stable manner.

The present invention also has the object of providing a hollow molded part manufacturing method and apparatus with a small utilized energy cost.

The present invention has the further object of providing a hollow molded part manufacturing method and apparatus with which, because no internal pressure is applied within the mold at time of molding, and no mold closing pressure is required, does not require a high hardness metal for the mold, and allows for the use of all electrically conductive materials, such as electrically conductive resin, thereby enabling the weight and cost of the mold to be reduced.

The present invention has the further object of providing a hollow molded part manufacturing method and apparatus with extremely high safety at time of molding, as well as high shape fidelity.

### Means for Resolving the Problem

The first invention is a method for manufacturing a hollow molded part, comprising:
a spraying step for forming a resin layer by spraying liquid resin with a differential electrical potential relative to the mold into a mold capable of separation into two or more parts from a spray fixture inserted from an opening portion in said mold;
a solidifying step for solidifying the resin layer; a mold parting step for opening the mold relative to the spray fixture and parting the solidified resin layer from the mold while it is held in the spray fixture;
and a removal step for removing from the spray fixture the resin layer held in the spray fixture.

The second invention is a method for manufacturing a hollow molded part, comprising:
a spraying step for forming a resin layer by spraying a liquid resin having a differential electrical potential relative to the mold into a mold capable of separation into two or more parts from a spray fixture inserted from an opening portion in said mold;
a solidifying step for solidifying the resin layer using a solidifying electromagnetic wave irradiation fixture in place of the spray fixture;
a mold parting step for opening the mold relative to the electromagnetic irradiation fixture and parting the solidified resin layer from the mold while it is held in the electromagnetic irradiation fixture;
and a removal step for removing the resin layer held in the electromagnetic irradiation fixture from the spray fixture.

The third invention is a method for manufacturing a hollow molded part, having:
a mold capable of separation into two or more parts;
a spray fixture inserted from an opening portion in said mold for forming a resin layer on the inside surface of the mold by spraying a charged liquid resin having a charge differential relative to the mold;
a mold drive means for opening the mold relative to the spray fixture and parting the solidified resin layer from the mold while holding it in the spray fixture;
and a removal means for removing the resin layer held in the spray fixture from that spray fixture.

The fourth invention is a hollow molded part manufacturing method, having:
a mold capable of separation into two or more parts;
a spray fixture inserted from an opening portion in said mold for forming a resin layer on the inside surface of the mold by spraying a charged liquid resin;
a solidifying electromagnetic wave irradiation fixture for applying solidifying electromagnetic waves, disposed in place of the spray fixture;
a mold drive means for opening the mold relative to the solidifying electromagnetic wave irradiation fixture and parting the solidified resin layer from the mold while it is held in the solidifying electromagnetic wave irradiation fixture;
and a removal means for removing the resin layer from the spray fixture while it is held in the solidifying electromagnetic wave irradiation fixture.

### Effect of the Invention

Using the hollow molded part manufacturing method and apparatus of the present invention, an effect can be gained whereby extremely thin hollow molded parts of uniform thickness can be easily and efficiently manufactured in a stable manner.

Also, using the hollow molded part manufacturing method and apparatus of the present invention, an effect can be gained whereby the cost of energy utilized is small.

In addition, using the hollow molded part manufacturing method and apparatus of the present invention, given that no internal pressure is applied within the mold at the time of molding, and therefore no pressure is required to close the mold, there is no requirement for a high hardness metal for the mold, and all electrically conductive materials, such as electrically conductive resin, may be used. Resins using gold powder, silver powder, copper powder, nickel powder, aluminum powder, chrome powder, carbon powder, or graphite powder as electrically conductive fillers may be used to obtain the effect of lightening and reducing the cost of molds. Electrically conductive plated resin may also be used as another mold material. In resin molds, using resins transmissive to electromagnetic waves enables irradiation by solidifying electromagnetic waves from outside the resin mold.

Furthermore, according to the hollow molded part manufacturing method and apparatus of the present invention, there are few mechanical drive parts and no major drive force is required, so very high safety during molding can be achieved.

The hollow molded part manufacturing method and apparatus of the present invention has the further advantage of having few parts forming burrs, and no overflow of material, so material losses do occur.

Injection molding or extrusion molding, or sheet molding, inflation molding, blow molding, compression molding, or the like make use of a thermoplastic resin solid at room temperature or a heat-cured resin. These thermoplastic resins or heat-cured resins require blending of colorants with a screw. In such instances there is a tendency for differences in the flow between the molten state resin and the colorants or additives to flow differently inside the resin flow path, leading to cosmetic or functional problems with products, such as welds, poor dispersion, or the like.

In the present invention, when resin raw materials which are liquid at room temperature, such as UV-cured resins or emulsions, are used, coloring agents or additives such as pigments and dyes may be pre-blended. Resin sprayed from the spray nozzle does not pass through a pathway, and reaches the mold surface as it is being uniformly dispersed due to the mutual electrical repulsion of the resin particles, so there is no risk of problems such as welds or poor dispersions arising.

Aspects of the present invention are given below. In the first and second inventions, the spraying step is carried out multiple times to form multiple resin layers.

In the first and second inventions,
the resin is a heat-cured resin; the mold heated in the spraying step is used and the solidifying step is carried out simultaneously with the spraying step.

In the first and second inventions,
the resin is a UV-cured resin,
and the solidifying electromagnetic wave irradiation fixture irradiates the resin layer with UV.

In the first and second inventions,
the resin is a light-cured resin,
and the solidifying electromagnetic wave irradiation fixture irradiates the resin layer with visible light.

In the first and second inventions,
the resin is a thermoplastic resin,
and utilizing the mold cooled in the spraying step, the solidifying step and the spraying step are carried out simultaneously.

In the first and second inventions,
the resin is an emulsion resin,
and in the spraying step an emulsion solvent is vaporized in the mold.

In the first and second inventions,
in the parting step the electrical charge of the mold is set to be the same as the electrical charge of the solidified resin layer.

In the first and second inventions,
the mold has a positive charge and the resin has a negative charge.

In the first and second inventions,
the mold has a negative charge and the resin has a positive charge.

In the first and second inventions, the mold is brought to ground and the resin has a negative charge.

In the first and second inventions,
the mold is brought to ground and the resin has a positive charge.

In the third and fourth inventions,
the mold is made of metal or electrically conductive resin.

In the third and fourth inventions,
the mold has a positive charge and the resin has a negative charge.

In the third and fourth inventions,
the mold has a negative charge and the resin has a positive charge.

In the third and fourth inventions,
the mold is brought to ground and the resin has a negative charge.

In the third and fourth inventions,
the mold is brought to ground and the resin has a positive charge.

### BRIEF DESCRIPTION OF FIGURES

FIG. 1: A schematic diagram of the hollow molded part manufacturing apparatus of a first embodiment of the present invention.

FIG. 2: A schematic diagram of the spraying state in the hollow molded part manufacturing apparatus of a first embodiment of the present invention.

FIG. 3: A schematic diagram of the mold-opening state in the hollow molded part manufacturing apparatus of a first embodiment of the present invention.

FIG. 4: A schematic diagram of the spraying state in the hollow molded part manufacturing apparatus of a second embodiment of the present invention.

FIG. 5: A schematic diagram of the solidifying state in the hollow molded part manufacturing apparatus of a second embodiment of the present invention.

FIG. 6: A schematic diagram of the mold-opening state in the hollow molded part manufacturing apparatus of a second embodiment of the present invention.

### EMBODIMENTS OF THE INVENTION

### First Embodiment

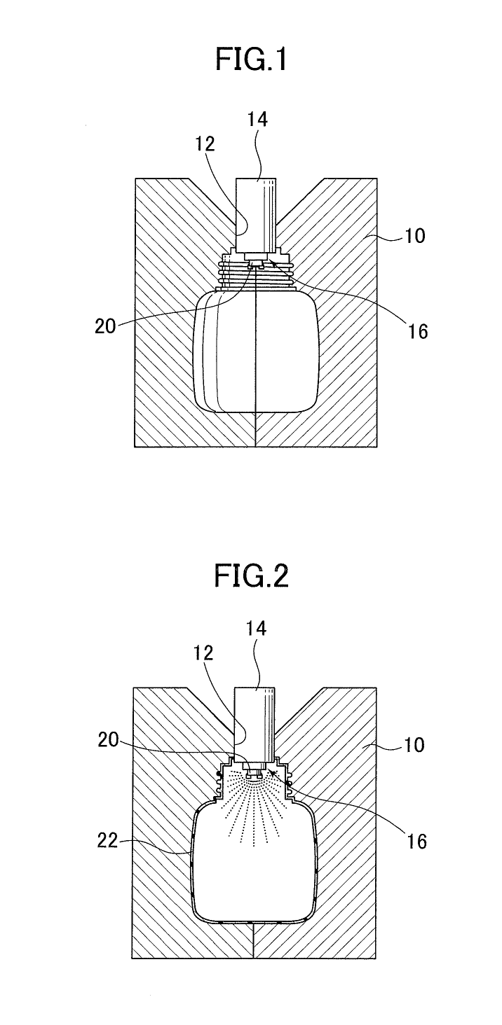

In the hollow molded part manufacturing apparatus of the first embodiment, as shown in FIG. 1, a nozzle portion insulated by an insulating body 14 with a gap tolerance of 0.2 mm or less is disposed on an opening 12 on a bottle mold 10, capable of division into two parts. The nozzle portion 16 has a nozzle body 20, being the spray nozzle of an electrostatic spray gun generally used for electrostatic coating. The nozzle body 20 is set to ground and a high voltage of 10 kV is applied to the bottle mold 10 to form an electrostatic field.

In the hollow molded part manufacturing apparatus of the first embodiment, negatively charged molding resin, not containing a binder, is sprayed from the nozzle portion 16. The molding resin, as shown in FIG. 2, forms a molding resin layer 22 with a uniform thickness of 0.01 to 2.0 mm, and preferably from 0.05 to 0.6 mm, on the inside surface of the bottle mold 10, and the molding resin layer 22 is tightly adhered to the inside surface of the bottle mold 10 by electrostatic force.

Examples of molding resin materials include epoxy resin, melamine resin, phenol resin, alkyd resin, amino-alkyd resin, vinyl resin, acrylic resin, urethane resin, silicone resin, silicon resin, fluorine resin, urea resin, polyacetal resin, olefin resins, styrene resins, vinyl chloride resins, polyester resins, polyimide resins, cellulose, drying oil, and the like.

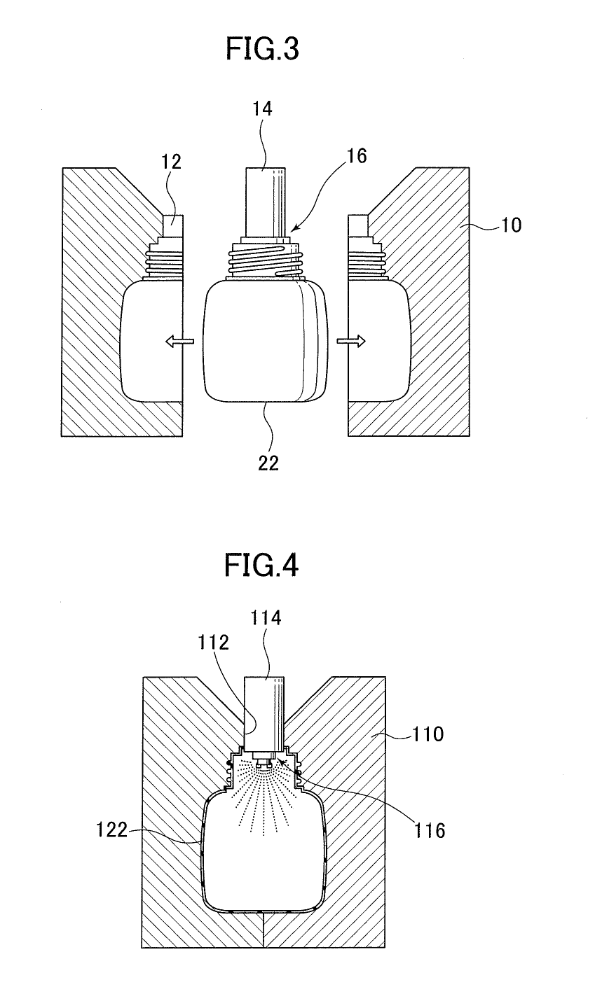

Following this, as shown in FIG. 3, the bottle mold 10 is opened into two parts about the affixed nozzle portion 16 and left attached to the molding resin layer 22. The molding resin layer 22 is removed from the nozzle portion 16 to form a bottle. The molding resin layer 22, i.e., the bottle, has an average thickness of 0.6 mm.

### Second Embodiment

In the hollow molded part manufacturing apparatus of the second embodiment, as shown in FIG. 4, as in the first embodiment, a nozzle portion 116 insulated by an insulating body 114 with a gap tolerance of 0.2 mm or less is disposed on an opening 112 on a bottle mold 110, capable of division into two parts. In the hollow molded part manufacturing apparatus of the second embodiment, negatively charged UV-cured resin, not containing a binder, is sprayed from the nozzle body 116. The UV-cured molding resin forms a molding resin layer 122 with a uniform thickness on the inside surface of the bottle mold 110, and said molding resin layer 122 is tightly adhered to the surface of the bottle mold 110 by electrostatic force.

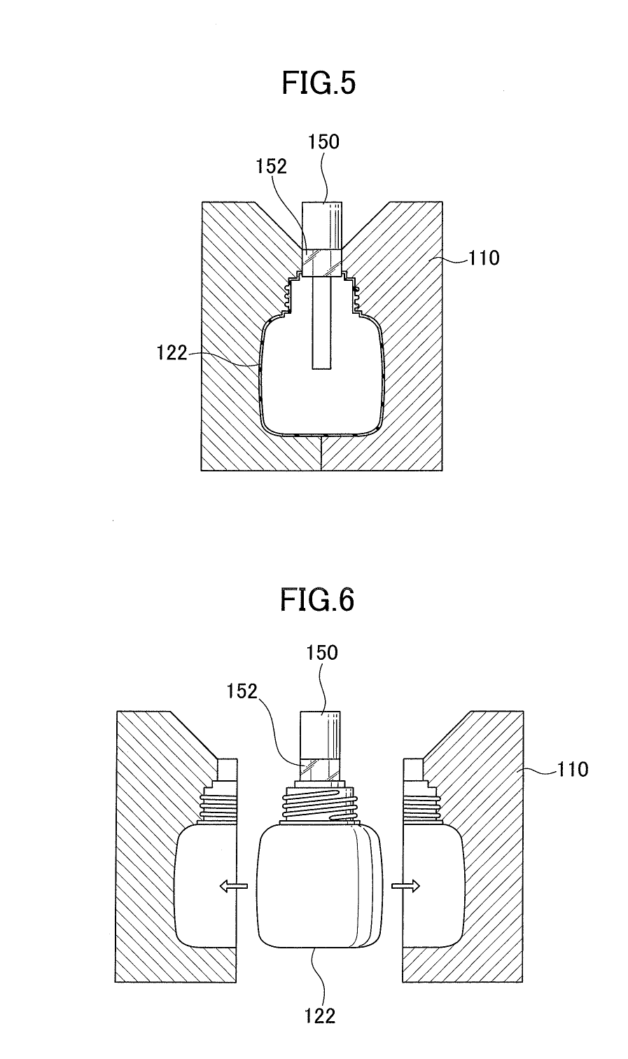

Thereafter, as shown in FIG. 5, the nozzle portion 116 is pulled out and a UV irradiating portion 150 is inserted in its place. The UV irradiating portion 150 irradiates with UV containing wavelengths of 200 to 450 nm; it has the same shaped cross section as the nozzle portion 116, and has a nozzle transparent body 152 with a gap tolerance relative to the mold opening of 0.2 mm or less, transmissive to UV.

Following this, as shown in FIG. 6, the bottle mold 110 is opened into two parts about the affixed UV irradiating portion 150, and the molding resin layer 122 is left attached to the UV irradiating portion 150. The molding resin layer 122 is removed from the UV irradiating portion 150 to form a bottle.

### Other Embodiments

The first and second embodiments each have one resin spraying step and one resin solidifying step, but a laminated molded part can be obtained by repeated iterations of each of those respective steps.

In the second embodiment a UV-cured resin was used, but other light-cured resins may also be used.

The bottle mold is constantly heated to 100° C. or above, an aqueous emulsion not containing a binder adhering to metal is electrostatically sprayed, and the resin is solidified using the heat of the bottle mold to vaporize any water component.

Conversely, the mold is kept at a constant 20° C. or below, a thermoplastic resin such as polyethylene or polypropylene is electrostatically sprayed in a molten state, and the resin is solidified by cooling from the bottle mold.

In addition, the spray nozzle is changed to a spray gun of the type generally used for powder coating, and a heat-cured resin is used as the raw material for spraying and sprayed onto the inside surface of a bottle mold constantly heated to the resin solidification temperature to solidify the resin. Since these methods do not require repeated heating and cooling of the mold, energy losses can be reduced to a minimum. At the same time, since there is no need to wait until the bottle mold temperature heats up or cools down to the temperature required for the next stage, there is an additional advantage of high productivity per bottle mold.

### EXPLANATION OF REFERENCE NUMERALS

10, 110: bottle molds 12, 112: openings 14, 114: insulating bodies 16, 116: nozzle portions 20, 120: nozzle bodies 22, 122: molding resin layers

1. A method for manufacturing a hollow molded part, comprising:
a spraying step for forming a resin layer by spraying liquid resin with a differential electrical potential relative to the mold into a mold capable of separation into two or more parts from a spray fixture inserted from an opening portion in said mold;
a solidifying step for solidifying the resin layer; a mold parting step for opening the mold relative to the spray fixture and parting the solidified resin layer from the mold while it is held in the spray fixture;
and a removal step for removing the resin layer held in the spray fixture from that spray fixture.

2. A method for manufacturing a hollow molded part, comprising:
a spraying step for forming a resin layer by spraying liquid resin with a differential electrical potential relative to the mold into a mold capable of separation into two or more parts from a spray fixture inserted from an opening portion in said mold;
a solidifying step for solidifying the resin layer using a solidifying electromagnetic wave irradiation fixture in place of the spray fixture; a mold parting step for opening the mold relative to the electromagnetic irradiation fixture and parting the solidified resin layer from the mold while it is held in the electromagnetic irradiation fixture;
and a removal step for removing the resin layer held in the electromagnetic irradiation fixture from the spray fixture.

3. The method for manufacturing a hollow molded part of claim 1, wherein the spraying step is carried out multiple times to form multiple resin layers.

4. The method for manufacturing a hollow molded part of claim 1, wherein
the resin is a heat-cured resin, and utilizing the mold heated in the spraying step,
the solidifying step and the spraying step are carried out simultaneously.

5. The method for manufacturing a hollow molded part of claim 1, wherein
the resin is a UV-cured resin, and in the solidifying step the solidifying electromagnetic wave irradiation fixture irradiates UV onto the resin layer.

6. The method for manufacturing a hollow molded part of claim 1, wherein
the resin is a light-cured resin,
and in the solidifying step the solidifying electromagnetic wave irradiation fixture irradiates visible light onto the resin layer.

7. The method for manufacturing a hollow molded part of claim 1, wherein
the resin is a thermoplastic resin,
and utilizing the mold cooled in the spraying step, the solidifying step and the spraying step are carried out simultaneously.

8. The method for manufacturing a hollow molded part of claim 1, wherein
the resin is an emulsion resin,
and in the spraying step an emulsion solvent is vaporized in the mold.

9. The method for manufacturing the hollow molded part of claim 1, whereby in the parting step, the electrical charge of the mold is set to be the same as the electrical charge of the solidified resin layer.

10. The method for manufacturing the hollow molded part of claim 1, wherein the mold is positively charged and the resin is negatively charged.

11. The method for manufacturing the hollow molded part of claim 1, wherein the mold is negatively charged and the resin is positively charged.

12. The method for manufacturing the hollow molded part of claim 1, wherein the mold is set to ground and the resin is negatively charged.

13. The method for manufacturing the hollow molded part of claim 1, wherein the mold is set to ground and the resin is positively charged.

14. A method for manufacturing a hollow molded part, having:
a mold capable of separation into two or more parts;
a spray fixture inserted from an opening portion in said mold for forming a resin layer on the inside surface of the mold by spraying a charged liquid resin having a charge differential relative to the mold;
a mold drive means for opening the mold relative to the spray fixture and parting the solidified resin layer from the mold while holding it in the spray fixture;
and a removal means for removing the resin layer held in the spray fixture from that spray fixture.

15. A hollow molded part manufacturing method, having:
a mold capable of separation into two or more parts;
a spray fixture inserted from an opening portion in said mold for forming a resin layer on the inside surface of the mold by spraying a charged liquid resin;
a solidifying electromagnetic wave irradiation fixture for applying solidifying electromagnetic waves, disposed in place of the spray fixture;
a mold drive means for opening the mold relative to the solidifying electromagnetic wave irradiation fixture and parting the solidified resin layer from the mold while it is held in the solidifying electromagnetic wave irradiation fixture;
and a removal means for removing the resin layer from the spray fixture while it is held in the solidifying electromagnetic wave irradiation fixture.

16. The method for manufacturing the hollow molded part of claim 14, wherein the mold is made of metal or electrically conductive resin.

17. The hollow molded part manufacturing apparatus of claim 14, wherein the mold is positively charged and the resin is negatively charged.

18. The hollow molded part manufacturing apparatus of claim 14, wherein the mold is negatively charged and the resin is positively charged.

19. The hollow molded part manufacturing apparatus of claim 14, wherein the mold is set to ground and the resin is negatively charged.

20. The method for manufacturing a hollow molded part of claim 2, wherein the spraying step is carried out multiple times to form multiple resin layers.

21. The method for manufacturing a hollow molded part of claim 2, wherein
the resin is a heat-cured resin, and utilizing the mold heated in the spraying step,
the solidifying step and the spraying step are carried out simultaneously.

22. The method for manufacturing a hollow molded part of claim 2, wherein
the resin is a UV-cured resin, and in the solidifying step the solidifying electromagnetic wave irradiation fixture irradiates UV onto the resin layer.

23. The method for manufacturing a hollow molded part of claim 2, wherein
the resin is a light-cured resin,
and in the solidifying step the solidifying electromagnetic wave irradiation fixture irradiates visible light onto the resin layer.

24. The method for manufacturing a hollow molded part of claim 2, wherein
the resin is a thermoplastic resin,
and utilizing the mold cooled in the spraying step, the solidifying step and the spraying step are carried out simultaneously.

25. The method for manufacturing a hollow molded part of claim 2, wherein
the resin is an emulsion resin,
and in the spraying step an emulsion solvent is vaporized in the mold.

26. The method for manufacturing the hollow molded part of claim 2, whereby in the parting step, the electrical charge of the mold is set to be the same as the electrical charge of the solidified resin layer.

27. The method for manufacturing the hollow molded part of claim 2, wherein the mold is positively charged and the resin is negatively charged.

28. The method for manufacturing the hollow molded part of claim 2, wherein the mold is negatively charged and the resin is positively charged.

29. The method for manufacturing the hollow molded part of claim 2, wherein the mold is set to ground and the resin is negatively charged.

30. The method for manufacturing the hollow molded part of claim 2, wherein the mold is set to ground and the resin is positively charged.

31. The method for manufacturing the hollow molded part of claim 15, wherein the mold is made of metal or electrically conductive resin.

32. The hollow molded part manufacturing apparatus of claim 15, wherein the mold is positively charged and the resin is negatively charged.

33. The hollow molded part manufacturing apparatus of claim 15, wherein the mold is negatively charged and the resin is positively charged.

34. The hollow molded part manufacturing apparatus of claim 15, wherein the mold is set to ground and the resin is negatively charged.
